(19) United States
(12) Patent Application Publication
(10) Pub. No.: US 2015/0268869 A1
(43) Pub. Date: Sep. 24, 2015

(54) STORAGE SYSTEM, INFORMATION PROCESSING DEVICE, AND CONTROL METHOD

(71) Applicant: FUJITSU LIMITED, Kawasaki-shi (JP)

(72) Inventor: Jun KATO, Kawasaki (JP)

(21) Appl. No.: 14/634,941

(22) Filed: Mar. 2, 2015

(30) Foreign Application Priority Data
Mar. 18, 2014 (JP) 2014-055033

(51) Int. Cl. G06F 3/06

(52) U.S. Cl. CPC G06F 3/0613; G06F 3/067; G06F 3/0656

(57) ABSTRACT

A storage system includes a first information processing device connected to a first storage device, and a second information processing device connected to a second storage device. The first information processing device includes a switch processing unit that connects the first storage device to the second information processing device. The second information processing device includes a second rewriting processing unit that rewrites data temporarily stored in the second storage device to the first storage device connected to the second information processing device by the switch processing unit.

### CROSS-REFERENCE TO RELATED APPLICATION

This application is based upon and claims the benefit of priority of the prior Japanese Patent application No. 2014-55033, filed on Mar. 18, 2014, the entire contents of which are incorporated herein by reference.

### FIELD

The embodiments discussed herein are directed to a storage system, an information processing device, and a control method.

### BACKGROUND

In the field of storages, research and development for big data have been made recently. A big data storage has a total capability of dozens to hundreds of petabytes (PB), and the capability thereof will reach one Exabyte (EB) soon.

The problem thereof is a total cost of ownership (TOC). For example, in the case of a system having a total capability of 1 EB, when a serial attached SCSI (small computer system interface) (SAS) driver of 1 TB (terabits) is used, 1,000, 000 drives are required and several tens of million yen is cost every month as a power cost.

In order to reduce a tremendous amount of power cost, it is necessary to diligently decrease the power of the drive but there is a need to turn on a power supply of the drive when reading from the drive and writing to the drive occur. Therefore, there is a case where a drive is unexpectedly started according to a request from a user, thereby causing reduction in power not to be achieved.

As a method for reducing power consumption in such a storage apparatus, a technology called “write offloading” is known.

In the write offloading, when there is a need to write data to a drive that is in a power-off state, the data is written (offloaded) to a non-used region (log region) of another drive that is in a power-on state. When the drive that has been in a power-off state and is an original writing destination is supplied with power, the offloaded data is written (rewritten) to the drive. Also, a technology called “inter-server write off loading” is known, which uses a drive connected to another server different from a server to which a drive that is in a power-off state is connected, as a drive being an offload target.

Therefore, even when writing to a drive that is in a power-off state is requested, power consumption can be reduced without unexpectedly starting a drive.
Patent Literature 1: Japanese Laid-open Patent Publication No. 2001-93220
Patent Literature 2: Japanese Laid-open Patent Publication No. 2005-228288
Non Patent Literature 1: Dushyanth Narayanan, et al. “Write Off-Loading: Practical Power Management for Enterprise Storage”, FAST '08: 6th USENIX Conference on File and Storage Technologies, Feb. 26-29, 2008

However, when rewriting of offloaded data is performed by the inter-serer offloading technology in the existing storage system, the data to be rewritten is caused to pass through a network between nodes. In this case, there is a problem that network load between servers increases.

### SUMMARY

Therefore, a storage system includes a first information processing device connected to a first storage device, and a second information processing device connected to a second storage device, wherein the first information processing device includes a switch processing unit that connects the first storage device to the second information processing device, and the second information processing device includes a second rewriting processing unit that rewrites data temporarily stored in the second storage device to the first storage device connected to the second information processing device by the switch processing unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a functional configuration of a storage system as an example of an embodiment;

FIG. 2 is a view explaining write offloading processing by intra-server write offloading in a storage system as an example of an embodiment;

FIG. 3 is a view explaining write offloading processing by inter-server write offloading in a storage system as an example of an embodiment;

FIG. 4 is a view illustrating a first example of load distribution technology by intra-server write offloading in a storage system as an example of an embodiment;

FIG. 5 is a view explaining a load distribution technology by inter-server write offloading in a storage system as an example of an embodiment;

FIG. 6 is a view illustrating a second example of load distribution technology by intra-server write offloading in a storage system as an example of an embodiment;

FIG. 7 is a view explaining rewriting processing by intra-server write offloading in a storage system as an example of an embodiment;

FIG. 8 is a view explaining rewriting processing by inter-server write offloading in a storage system as an example of an embodiment;

FIG. 9 is a diagram explaining an example of write off loading processing in a storage system as an example of an embodiment;

FIG. 10 is a view explaining write offloading processing in a storage system as an example of an embodiment;

FIG. 11 is a diagram illustrating an example of processing of acquiring a circulation server list in a storage system as an example of an embodiment;

FIG. 12 is a view illustrating an example of intra-server rewriting processing in a storage system as an example of an embodiment;

FIG. 13 is a view illustrating an example of processing of switching storage devices in a storage system as an example of an embodiment;

FIG. 14 is a diagram illustrating an example of processing of changing an offload target server in a storage system as an example of an embodiment; and

FIG. 15 is a diagram illustrating an exemplary state after rewriting processing of offload data is completed in a storage system as an example of an embodiment.

### DESCRIPTION OF EMBODIMENT(S)

Hereinafter, embodiments of a storage system, an information processing device, and a control method will be described below with reference to the drawings. However, the embodiment described below is merely an example and is not intended to exclude various modifications or technical applications. That is, the present embodiments can be practiced in various ways without departing from the scope thereof.

Further, the drawings are not limited as including only components illustrated in the drawings and may be intended to include other functions.

Since the same reference signs indicate the same portions in the drawings, a description thereof is omitted.

### [A] Example of embodiment

[A-1] System Configuration

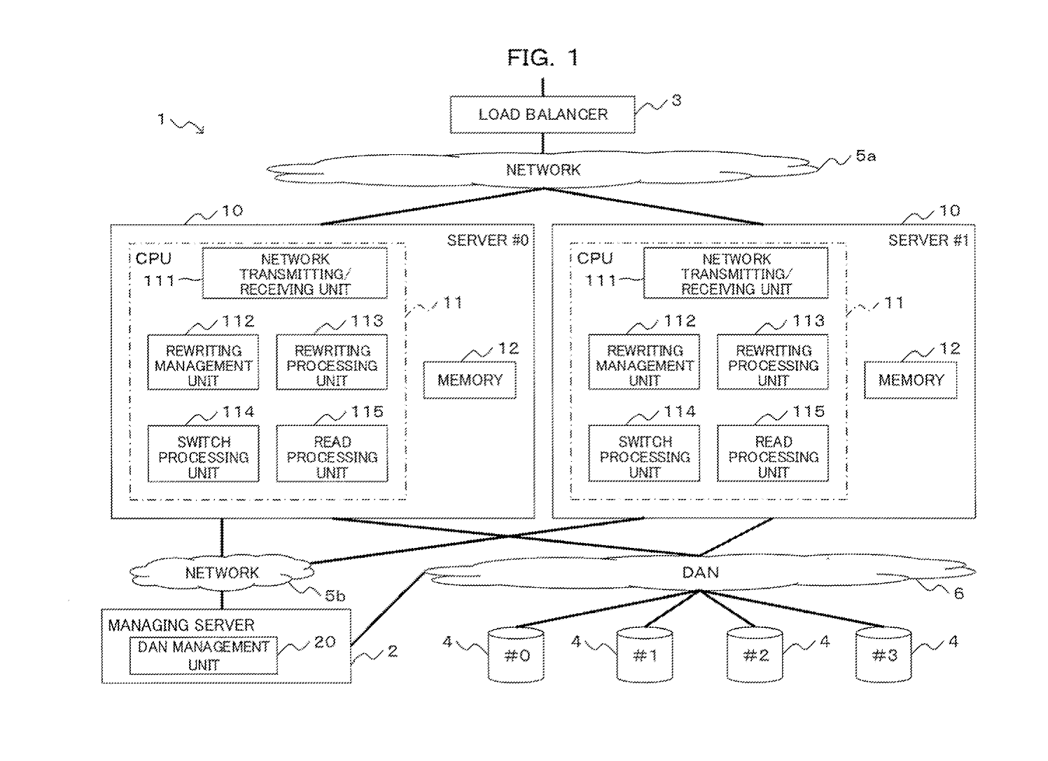

FIG. 1 is a view schematically illustrating a functional configuration of a storage system as an example of an embodiment.

According to the example of the present embodiment, the storage system 1 provides a storage space to a server (information processing device) 10 and has a write offloading function.

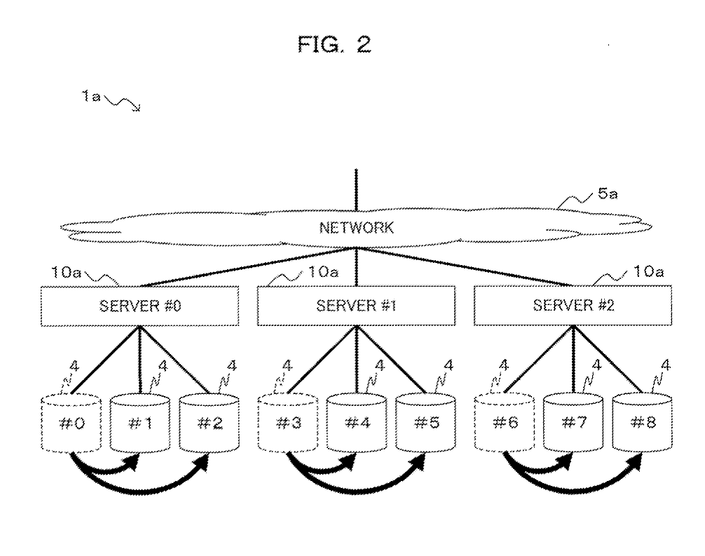

Write offloading will be described below with reference to FIGS. 2 to 8, before a detailed functional configuration of the storage system 1 is described as an example of the present embodiment.

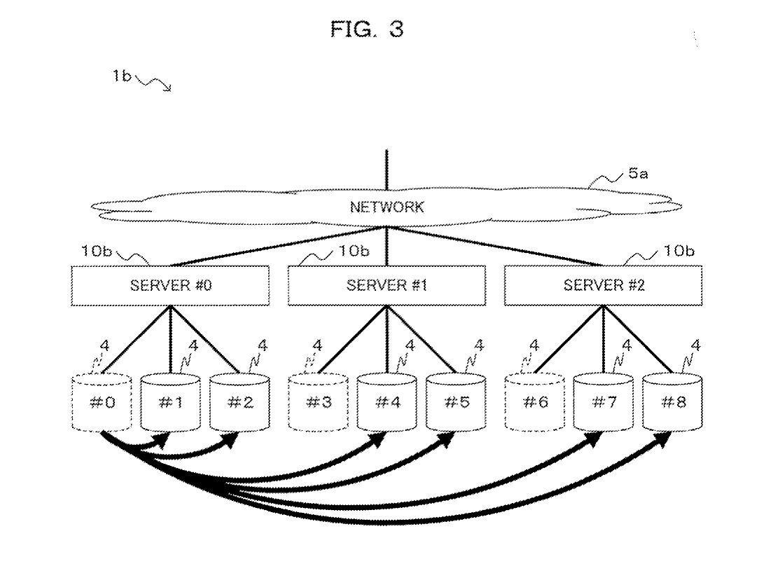

As the write offloading, there are considered an intra-server write offloading which is described with reference to FIG. 2 and inter-server write off loading which is described with reference to FIG. 3. Intra-server write off loading refers to performing write offloading in a state of being closed within a server and inter-server write offloading refers to performing write offloading in a state of not being closed within a server.

First, the intra-server write offloading will be described.

FIG. 2 is a view explaining write offloading processing by intra-server write offloading in the storage system which is an example of the present embodiment.

The storage system 1a illustrated in FIG. 2 provides a storage area to a server 10a and are equipped with an intra-server write offloading function. The storage system 1a includes a plurality of (three in the illustrated example) servers (server #0 to #2) 10a and a plurality of (nine in the illustrated example) storage devices (storage device #0 to #8) 4.

In the following description, reference signs “server #0”, “server #1” or “server #2” is used when it is necessary to specify one of the plurality of servers. However, reference sign “server 10a” is used when an arbitrary server device is designated. In the following description, reference signs “storage device #0”, “storage device #1”, “storage device #2”, “storage device #3”, “storage device #4”, “storage device #5”, “storage device #6”, “storage device #7”, and “storage device #8” are used when it is necessary to specify one of the plurality of storage devices. However, reference sign “storage device 4” is used when an arbitrary storage device is designated.

The respective server 10a are communicably connected to each other through a network 5a. Also, the servers 10a are communicably connected to the storage devices 4 through, for example, SAS or serial advanced technology attachment (SATA). Specifically, the server #0 is communicably connected to the storage devices #0 to #2, the server #1 is communicably connected to the storage devices #3 to #5, and the server #2 is communicably connected to the storage devices #6 to #8.

The storage device 4 is an existing device that stores data in readable/writable manner, and examples thereof include a hard disk drive (HDD) or a solid state drive (SSD). The storage devices 4 have the same functional configuration as each other.

The server 10a is a computer equipped with a server function. Although three servers 10a are provided in the example illustrated in FIG. 2, at most two or at least four servers 10a may be provided.

In the drawings, the storage device 4 indicated by a dashed line represents a storage device which is in a power-off state or a power-on state but is in a spin down state, and the storage device indicated by a solid line represents a storage device which is in a power-on state and is not in a spin down state. That is, in the example illustrated in FIG. 2, the storage devices #0, #3 and #6 are in a power-off state, and the storage devices #1, #2, #4, #5, #7 and #8 are in a power-on state.

In the write offloading, non-used areas of the storage devices 4 are used as log areas. In a case where a data write command is issued to the storage device 4 which is in a power-off state, the server 10a writes (offloads) data to another storage device 4 which is in a power-on state, instead of performing writing to the storage device 4 being a writing destination.

According to the intra-server write offloading, in a case where a data write command is issued to the storage device 4 which is connected to the server 10a itself and is in a power-off state, the server 10a offloads data to another storage device 4 which is connected to the server 10a itself and is in a power-on state. That is, the intra-server write offloading is offload processing that is closed in a server.

In the example illustrated in FIG. 2, in a case where a data write command is issued to the storage device #0 which is in a power-off state, the server #0 offloads data to the storage devices #1 and #2 which are in a power-on state. Also, in a case where a data write command is issued to the storage device #3 which is in a power-off state, the server #1 offloads data to the storage devices #4 and #5 which are in a power-on state. Further, in a case where a data write command is issued to the storage device #6 which is in a power-off state, the server #2 offloads data to the storage devices #7 and #8 which are in a power-on state.

In the following description, there is a case where the storage device 4 to which data is to be written instead of the storage device 4 being an original writing destination, which is in a power-off state is referred to as the “storage device 4 being an offload destination”

Next, the inter-server write offloading will be described.

FIG. 3 is a view explaining write offloading processing by the inter-server write offloading in a storage system as an example of an embodiment.

The storage system 1b illustrated in FIG. 3 provides a storage area to the server 10b and is equipped with the inter-server write offloading function. The storage system 1b includes a plurality of (three in the illustrated example) servers (server #0 to #2) 10b and a plurality of (nine in the illustrated example) storage devices (storage devices #0 to #8) 4. Since the storage device 4 illustrated in FIG. 3 has the same functional configuration as the storage device 4 illustrated in FIG. 2, a description thereof is omitted.

In the following description, reference signs “server #0”, “server #1” or “server #2” is used when it is necessary to specify one of the plurality of servers. However, reference sign “server 10b” is used when an arbitrary server device is designated.

The server 10b is a computer equipped with a server function. Although three servers 10b are provided in the example illustrated in FIG. 3, at most two or at least four servers 10b may be provided.

According to the inter-server write offloading, in a case where a data write command is issued to the storage device 4 which is connected to the server 10b itself and is in a power-off state, the server 10b offloads data to another storage device 4 which is connected to the server 10b itself and another server 10b and is in a power-on state. That is, the inter-server write offloading is offload processing that is not closed in a server.

In the example illustrated in FIG. 3, in a case where a data write command is issued to the storage device #0 which is in a power-off state, the server #0 offloads data to the storage devices #1 and #2, the server #1 offloads data to the storage devices #4 and #5, and the server #2 offloads data to the storage devices #7 and #8. Also, in a case where a data write command is issued to the storage device #3 which is in a power-off state, the server #0 offloads data to the storage devices #1 and #2, the server #1 offloads data to the storage devices #4 and #5, and the server #2 offloads data to the storage devices #7 and #8 (not illustrated). Also, in a case where a data write command is issued to the storage device #6 which is in a power-off state, the server #0 off loads data to the storage devices #1 and #2, the server #1 offloads data to the storage devices #4 and #5, and the server #2 off loads data to the storage devices #7 and #8 (not illustrated).

Subsequently, load distribution in write offloading will be described.

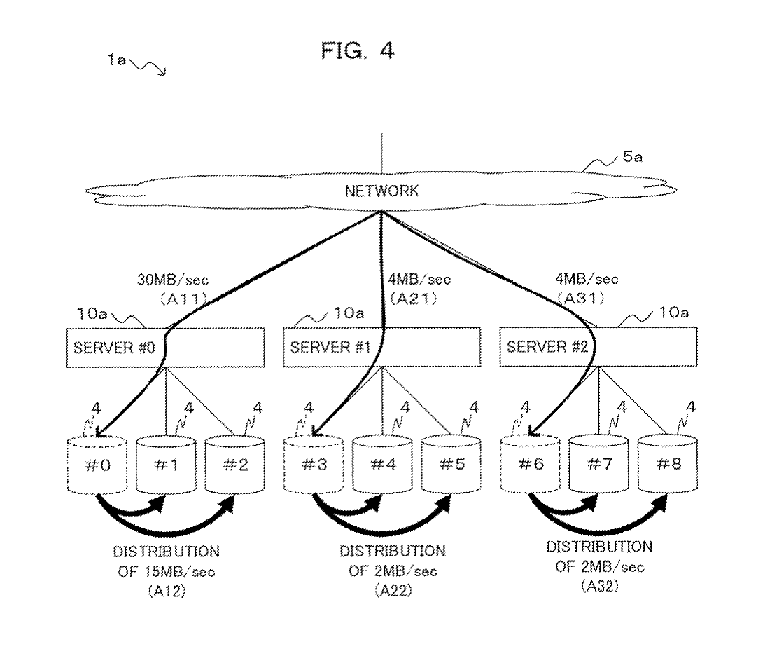

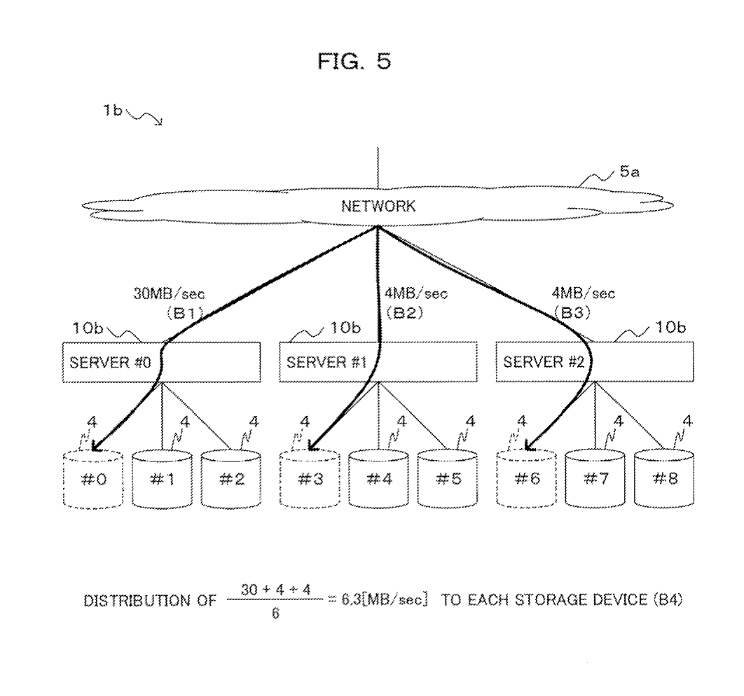

FIG. 4 is a view explaining a first example of load distribution technology by the intra-server write offloading in a storage system as an example of the embodiment, and FIG. 5 is a view illustrating load distribution technology by the inter-server write offloading.

In the write offloading, the amount of data which is offloaded to the storage device 4 being an offload destination which is in a power-on state varies depending on whether write offloading is performed by the intra-server write offloading or the inter-server write offloading.

Also, load distribution in the intra-server write offloading will be described.

In an example illustrated in FIG. 4, storage devices #0, #3 and #6 which are in a power-off state are about to write data of 30 MB/sec (megabyte/second), 4 MB/sec, and 4 MB/sec respectively (see reference signs A11, A21 and A31).

The server #0 distributes and writes data for the storage device #0 to the storage devices #1 and #2 on a 15 MB/sec basis (see reference sign A12). Also, the server #1 distributes and writes data for the storage device #3 to the storage devices #4 and #5 on a 2 MB/sec basis (see reference sign A22). Also, the server #2 distributes and writes data for the storage device #6 to the storage devices #7 and #8 on a 2 MB/sec basis (see reference sign A32). That is, each server 10 equally distributes and writes data which is to be written in the storage device 4 that is in a power-off state to other storage devices 4 connected to the same server 10 as the storage device 4 that is in a power-off state.

Thus, according to the intra-server write offloading, the amount of data which is offloaded to the storage device 4 which is in a power-on state is different between the servers 10a.

Subsequently, load distribution in inter-server write offloading will be described.

Similarly, in an example illustrated in FIG. 5, storage devices #0, #3 and #6 which are in a power-off state are trying to write data at 30 MB/sec, 4 MB/sec, and 4 MB/sec respectively (see reference signs B1, B2 and B3).

Each server 10b distributes data for the storage devices #0, #3 and #6 which are in a power-off state to the storage devices #1, #2, #4, #5, #7 and #8 on the basis of

$$\frac{30 + 4 + 4}{6} = 6.3 [ MB / sec ] \qquad [ Mathematical Formula 1 ]$$

and writes distributed data to the storage devices #1, #2, #4, #5, #7 and #8 (see reference sign B4).

Specifically, the server #0 distributes and writes data for the storage devices #0, #3 and #6 to the storage devices #1 and #2 on a 6.3 MB/sec basis. Also, the server #1 distributes and writes data for the storage devices #0, #3 and #6 to the storage devices #4 and #5 on a 6.3 MB/sec basis. In addition, the server #2 distributes and writes data for the storage devices #0, #3 and #6 to the storage devices #7 and #8 on a 6.3 MB/sec basis.

Therefore, according to the inter-server write offloading, the amount of data which is offload to the storage device 4 which is in a power-on state is identical between the servers 10b, in regardless of to which server 10b the storage device 4 which is a power-off state is connected. That is, according to the inter-server write offloading, it is equalize increases in load of the respective storage devices 4 due to offloading.

Subsequently, load distribution in intra-server write offloading will be described again.

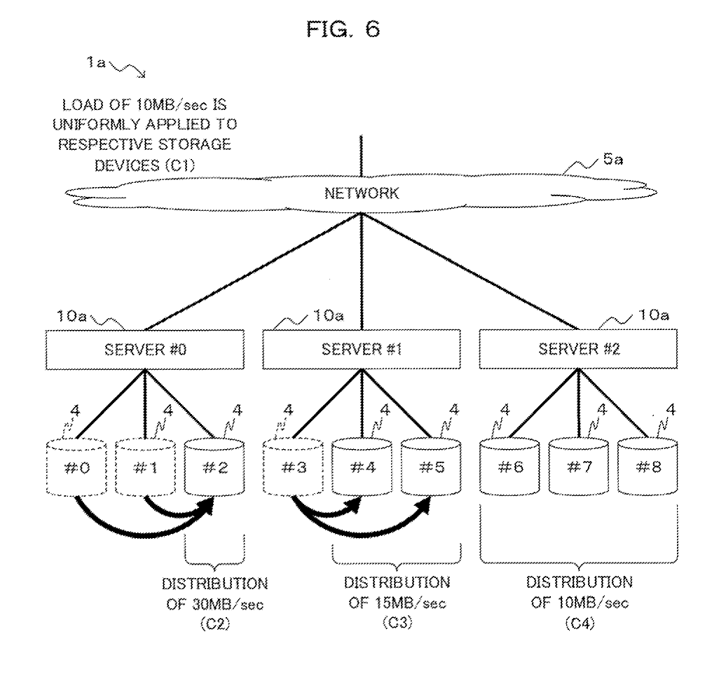

FIG. 6 is a view explaining a second example of load distribution technology by intra-server write offloading in a storage system which is an example of an embodiment.

In the example illustrated in FIG. 6, storage devices #0, #1 and #3 are in a power-off state, and storage devices #2 and #4 to #8 are in a power-on state. That is, the server #0 is connected to the two storage devices #0 and #1 which are in a power-off state, the server #1 is connected to the one storage device #3 which is in a power-off state, and the server #2 is not connected to the storage device 4 which is in a power-off state.

Load of 10 MB/sec is uniformly applied to the respective storage devices 4 (see reference sign C1).

The server #0 collects data for the storage devices #0 to #2 and writes the data to the storage device #2 at 30 MB/sec (see reference sign C2). Also, the server #1 distributes and writes data for the storage devices #3 to #5 to the storage devices #4 and #5 on a 15 MB/sec basis (see reference sign C3). Also, the server #2 distributes and writes data for the storage devices #6 to #8 to the storage devices #6 and 48 on a 10 MB/sec basis (see reference sign C4).

Therefore, according to the intra-server write offloading, although load is uniformly applied to the respective storage devices 4, the number of the storage devices 4 which are in a power-off state is different between the servers 10a, and therefore, the increases in load of the storage devices 4 due to write offloading are not uniform. In the example illustrated in FIG. 6, the storage device #2 has three times load as compared to the storage devices #6 to #8. When a difference in load between the storage devices 4 increases, entire performance of the storage system 1a is limited by the storage device 4 which is subjected to high load and ideal peak performance is likely not to be shown.

Therefore, in order to allow the storage devices 4 to be subjected to uniform load, it is considered to equalize the numbers of the storage devices 4 which is in a power-off state for the servers 10a.

However, according to write offloading, in the case of performing reading processing of data which does not exist in a log region, it is required to turn on the storage device 4 which is in a power-off state. That is, although the number of the storage devices 4 which are in a power-off state becomes identical between the servers 10a initially, when reading processing of data which does not exist in a log region occurs, the number of the storage devices 4 which are in a power-off state becomes different between the servers 10a.

Next, rewriting processing by write offloading will be described.

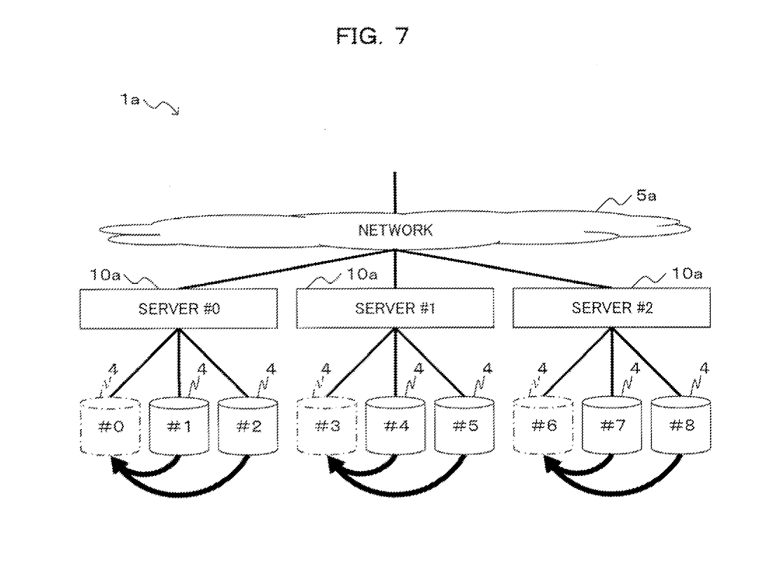

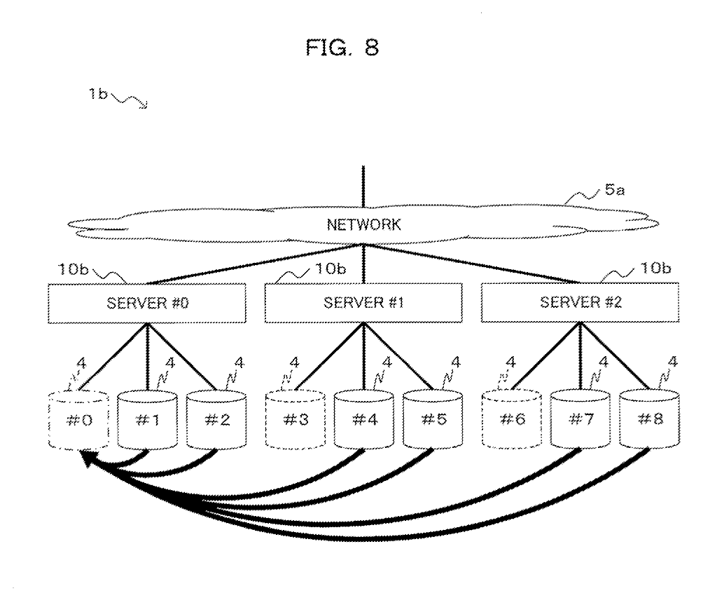

FIG. 7 is a view explaining rewriting processing of by the intra-server write offloading in a storage system as an example of the embodiment, and FIG. 8 is a view illustrating rewriting processing by the inter-server write offloading.

In the drawings, the storage device 4 indicated by a dot dashed line is illustrated as being the storage device 4 supplied with power from a power-off state and is subjected to rewriting processing. That is, in the example illustrated in FIG. 7, storage devices #0, #3 and #6 are subjected to rewriting processing, and in the example illustrated in FIG. 8, a storage device #0 is subjected to rewriting processing.

First, rewriting processing in the intra-server write offloading will be described.

As illustrated in FIG. 7, upon intra-server write offloading, in a case the storage devices #0, #3 and #6 which are original storage destinations are supplied with power after write offloading, each server 10a rewrites offload data which is stored in the log region of the storage device 4 which is an offload destination to the storage device 4 which is supplied with power. Specifically, the server #0 rewrites offload data which is stored in the log regions of the storage devices #1 and #2 which are offload destinations to the storage device #0 which is supplied with power. Also, the server #1 rewrites offload data which is stored in the log regions of the storage devices #4 and #5 which are offload destinations to the storage device #3 which is supplied with power. Further, the server #2 rewrites offload data which is stored in the log regions of the storage devices #7 and #8 which are offload destinations to the storage device #6 which is supplied with power.

In the following description, the storage device 4 that rewrites offloaded data is also referred to as a “storage device 4 being a rewrite destination”.

Therefore, according to the intra-server write offloading, the storage device 4 being an offload destination and the storage device 4 being a rewrite destination are connected to the same server 10a. Therefore, it is possible to rewrite data in a state of being closed within the server 10a, without requiring inter-node communication.

Next, rewriting processing in inter-server write offloading will be described.

As illustrated in FIG. 8, upon inter-server write offloading, when the storage device #0 which is an original storage destination is supplied with power after write offloading, each server 10a rewrites offload data which is stored in the log region of the storage device 4 being an offload destination to the storage device 4 which is supplied with power. Specifically, the server #0 rewrites offload data which is stored in the log regions of the storage devices #1 and #2 which are offload destinations to the storage device #0 which is supplied with power. Also, the server #1 transmits offload data which is stored in the log regions of the storage devices #4 and #5 to the server #0 through a network 5a and the server #0 rewrites the transmitted offload data to the storage device #0 which is supplied with power. Also, the server #2 transmits offload data which is stored in the log regions of the storage devices #7 and #8 to the server #0 through the network 5a and the server #0 rewrites the transmitted offload data to the storage device #0 which is supplied with power.

In this way, since, upon inter-server write offloading, the storage device 4 being an offload destination and the storage device 4 being a rewrite destination are not connected to the same server 10a, inter-node communication occurs. That is, upon the inter-server write offloading, in order to perform transmission of data between the servers 10, system resources, such as a central processing unit (CPU) or network bandwidth, are wasted.

The waste of system resources is likely to increase particularly in the case of workload in which processing of writing time-series data, such as accumulation of sensor data, occupies most thereof as an example of big data storage workload. Since, in the workload which such writing is of great importance, possibility that there is occurring a case in which there is a need to perform reading processing of data which does not exist in the log region of which the storage device 4 needs to be supplied with power is relatively low, the storage device that has been in a power-off state can be maintained in the power-off state for a long period of time. However, in such a case, since the amount of data that needs to be rewritten in a case where power is supplied increases compared to a period of time for which the power-off state has been maintained, a large volume of data needs to be transmitted and received through inter-node communication and a large number of system resources are consumed upon rewriting.

As described above, according to the intra-server write offloading, inter-node communication does not occur upon rewriting processing, but load applied to the respective storage devices 4 due to write offloading becomes non-uniform.

On the other hand, in the inter-server write offloading, load applied to the respective storage devices 4 due to offloading becomes uniform, but inter-node communication occurs upon rewriting processing.

Therefore, as illustrated in FIG. 1, the storage system 1 according to an example of the present embodiment includes a plurality of (two in the illustrated example) servers (servers #0 and #1; information processing devices) 10, a managing server 2, a load balancer (managing device, load distribution device) 3, and a plurality of (four in the illustrated example) storage devices 4. Since the storage device 4 has the same functional configuration as the storage device 4 included in the storage systems 1a and 1b illustrated in FIGS. 2 and 3, a description thereof is omitted.

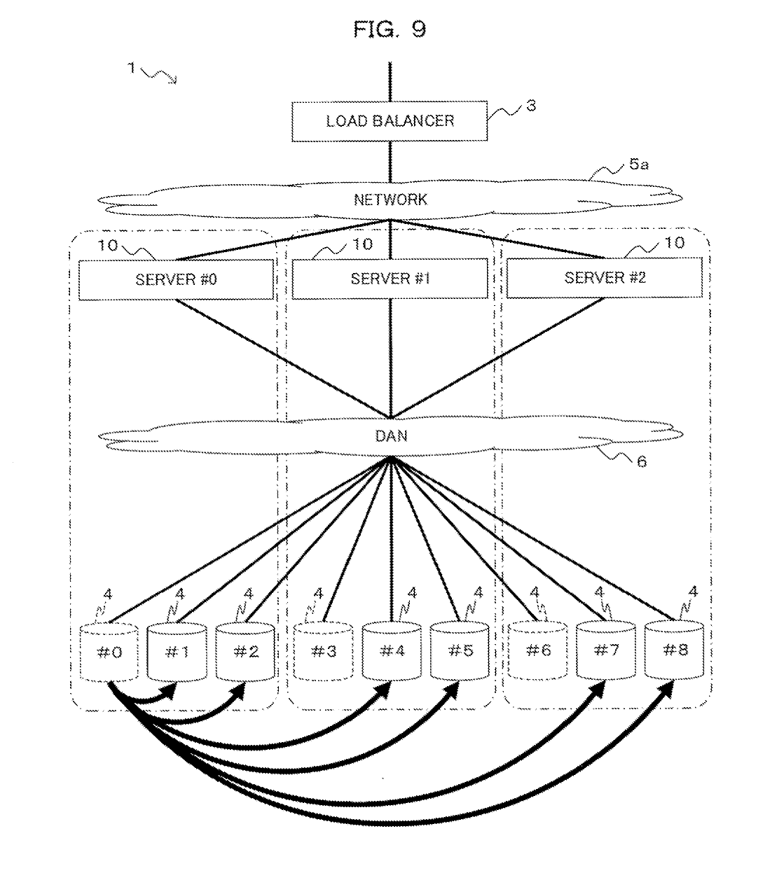

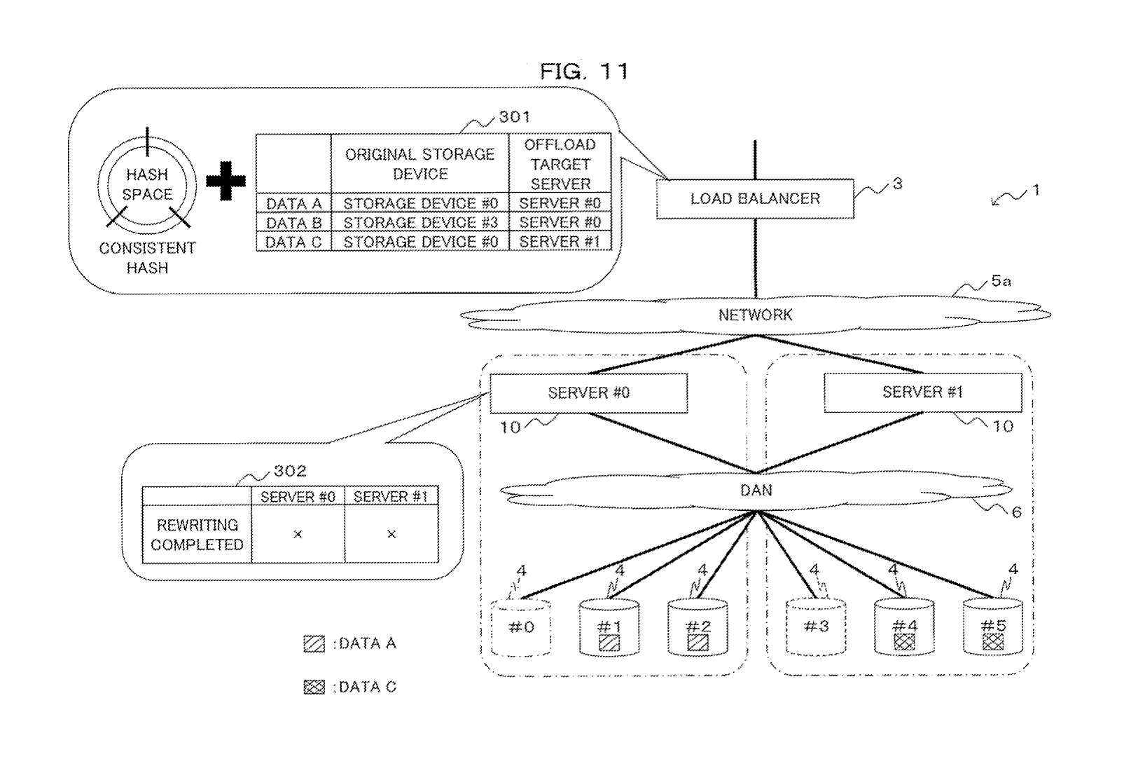

Note that the numbers of the servers 10 and the storage devices 4 which are included in the storage system 1 are not limited to the example illustrated in FIG. 1, and can be varied in various manners. For example, the storage system 1 may include three servers 10 and nine storage devices 4 as described with reference to FIG. 9 or include two servers 10 and six storage devices 4 as described with reference to FIG. 11.

In the following description, reference signs “server #0”, “server #1” or “server #2” is used when it is necessary to specify one of the plurality of servers. However, reference sign “server 10” is used when an arbitrary server device is designated

The respective servers 10 and the load balancer 3 are communicably connected to each other through the network Sa and the respective servers 10 and the managing server 2 are communicably connected to each other through a network 5b. Also, the respective servers 10 and the respective storage devices 4 are communicably connected to each other through a disk area network (DAN) 6.

The DAN 6 is an interconnect including a switch (relay device) (not illustrated) and having a function of arbitrarily switching connections between the servers 10 and the storage devices 4. According to the present exemplary embodiment, it is referred to as a DAN 6 in a sense of being an interconnect that connects disks, in order for discrimination from a storage area network (SAN) due to an existing fiber channel or the like. The DAN 6 can achieve both high performance and low cost since connect portions corresponding to existing local disks. The DAN 6 has the following characteristics unlike SAN.

Topology: the plurality of servers 10 (nodes) do not need to share a single storage device 4 (target).

Routing: a simple switch may be possible.

Since topology, routing, or the like is easily implemented, implementation is possible with low cost. Also, the DAN 6 connects to physical disk resources rapidly and smoothly by configuring a group of the storage devices 4 (see dot dashed frames illustrated in FIG. 9 or the like). Therefore, it is possible to provide a disk configuration suitable for system requirements and improve use efficiency of storage drive resources, by connecting the servers 10 and the storage devices 4 by the DAN 6.

In an example of the present embodiment, the DAN 6 has a function of switching the storage devices 4 to be connected to the servers 10 and connects the respective storage devices to the respective servers 10 as local disks. Therefore, the server 10 performs reading and writing on the storage devices 4 through the DAN 6.

Instead of the DAN 6, the servers 10 and the storage devices 4 may be connected by using a commercially available SAS switch, iSCSI or the like. The commercially available SAS performs switching of path routes by a switch and can switch the storage devices. Also, the iSCSI can switch the storage devices 4 by cutting off connection to the storage device 4 to the server 10 of the switching source and then reconnecting the storage device 4 to the server 10 of the switching destination.

The load balancer 3 is a device that distributes load to a plurality of servers 10 such that access load is collectively imposed on a specific server 10. The load balancer 3 grasps which data exists in the storage devices 4 or which data is offloaded to the log region of which storage device 4. When a data read request and a data write request occur, the load balancer 3 allocates the requests to an appropriate storage device 4. The load balancer 3 combines consistent hash and the hash table 301 which are described below by using FIG. 11 or the like, and performs allocation of the requests. The hash table 301 is a table generated by mapping data names of offloaded data to identifiers of offload target server.

The load balancer 3 acquires identifiers of the storage devices 4 being storage destinations by using the consistent hash with respect to a read request for data that is not offloaded and acquires identifiers of the storage device 4 being offload targets by searching data names corresponding to the hash table 301 with respect to other requests. In this way, it is prevented to allocate the read request for offloaded data to the storage device 4 which is in a power-off state unexpectedly.

The managing server 2 includes a CPU and a memory (which are not illustrated) and the CPU included in the managing server 2 functions as the DAN management unit 20.

The DAN management unit 20 performs operation of the DAN 6 based on an instruction from the switch processing unit 114 as one function of the CPU 11 which is included in the server 10 and is described below. Specifically, the DAN management unit 20 switches the servers 10 that are connection destinations of the respective storage devices 4 by controlling the switch of the DAN 6 as described above, according to the instruction of the switch processing unit 114. For example, in the example illustrated in FIG. 1, when the server #0 is connected to the storage device #0, and an instruction to switch the storage device #0 to the server #1 is received from the switch processing unit 114 of the server #0, the DAN management unit 20 controls the switch such that the storage device #0 is connected to the server #1. Although the DAN management unit 20 is disposed in the managing server 2 that is separated from the server 10 in the example illustrated in the drawing, the server 10 may have a function as the DAN management unit 20.

The server 10 is a computer equipped with a server function and the server #0 and the server #1 have the same functional configuration as each other. The server 10 includes a CPU (computer) 11 and a memory 12.

The memory 12 is a storage device including a read only memory (ROM) and a random access memory (RAN). In the ROM of the memory 12, programs, such as basic input/output system (BIOS), are recorded. A software program on the memory 12 is appropriately loaded to the CPU 11 and executed. Also, the RAM of the memory 12 is used as a primary recording memory or a work memory.

The CPU 11 is a processing device which performs various control or operations and realizes various functions by performing an operating system (OS) or a program stored in the memory 12. That is, as illustrated in FIG. 1, the CPU 11 functions as the network transmitting/receiving unit (transmitting unit) 111, the rewriting management unit 112, the rewriting processing unit (a first rewriting processing unit and a second rewriting processing unit) 113, the switch processing unit 114, and the read processing unit 115.

Programs (control programs) which realize functions as the network transmitting/receiving unit 111, the rewriting management unit 112, the rewriting processing unit 113, the switch processing unit 114, and the read processing unit 115 are provided in the form of being stored in a computer-readable recording medium, such as a flexible disk, a CD (CD-ROM, CD-R, CD-RW, or the like), a DVD (DVD-ROM, DVD-RAM, DVD-R, DVD-RW, DVD+R, DVD+RW, HD, DVD, or the like), a blu-ray disk, a magnetic disk, an optical disk, or an electromagnetic disk. Then, the computer reads the program from the recording medium, transfers and stores the program to and into an internal storage device or an external storage device and uses the program. Further, the program may be recorded on a storage device (recording medium) such as, for example, a magnetic disk, an optical disk, or a magneto-optical disk, and may be provided from the storage device to the computer through a communication path.

In the case of realizing functions as the network transmitting/receiving unit 111, the rewriting management unit 112, the rewriting processing unit 113, the switch processing unit 114, and the read processing unit 115, a program stored in an internal storage device (in the present embodiment, the memory 12) is executed by a microprocessor (in the present embodiment, the CPU 11) of the computer. In this case, the program recorded on a recording medium may be read out and executed by the computer.

The network transmitting/receiving unit 111 performs transmission/reception of data with another server 10, the load balancer 3, or the like through the network Sa. Also, the network transmitting/receiving unit 111 receives the circulation server list (storage destination information) 302 (described below with reference to FIG. 11 or the like) which is received by the load balancer 3 and again transfers the circulation server list 302 to the rewriting management unit 112. Also, the network transmitting/receiving unit ill transmits the circulation server list 302 updated by the rewriting management unit 112 and information related to the server 10 being a switching target of the storage device 4 being a rewriting target to the load balancer 3 and another server 10. Also, in the case of connecting the storage device 4 being a rewriting target to another server 10, when an access request for the storage device 4 being a rewriting target occurs, the network transmitting/receiving unit 111 transmits (transfers) the occurring access request to the another server 10 to which the storage device 4 being the rewriting target is connected.

The rewriting management unit 112 performs rewriting processing within the server 10 by using the rewriting processing unit 113, and switches the storage device 4 being a rewriting target to another server 10 by using the switch processing unit 114. Also, the rewriting management unit 112 acquires the circulation server list 302 from the load balancer 3 through the network transmitting/receiving unit 111. Further, when rewriting processing within the server 10 is completed, the rewriting management unit 112 updates the circulation server list 302 and transmits the updated the circulation server list 302 to the load balancer 3 and another server 10 through the network transmitting/receiving unit 111. The rewriting management unit 112 transmits an instruction for rewriting processing to the server 10 being a switching target of the storage device 4 being a rewriting target along with the updated circulation server list 302.

The rewriting processing unit 113 acquires a list of data (not illustrated) which needs to be rewritten in the storage device 4 being a rewriting target from the log regions of the respective storage devices 4 and rewrites data included in the acquired list to the storage device 4 being a rewriting target. In other words, in a case where the storage device 4 being a rewriting target is connected to the server 10 itself, the rewriting processing unit 113 rewrites data temporarily stored in the storage device 4 being an offload target to the storage device 4 being a rewriting target.

The switch processing unit 114 performs switching of the storage devices 4 through the DAN management unit 20. Specifically, the switch processing unit 114 connects the storage device 4 being a rewriting target to another server 10 by controlling a switch between the server 10 and the storage device 4 being a rewriting target in the DAN management unit 20.

In an example of the present embodiment, unlike an existing storage system, the servers 10 are connected to the storage devices 4 through the DAN 6, and therefore, it is possible to dynamically change a connection relationship between the servers 10 and the storage devices 4 by the function of the switch processing unit 114. In the following description, for simplification, one server 10 is connected to one storage device 4 but a plurality of servers 10 may be connected to one storage device 4 (the plurality of servers 10 share one storage device 4). When the plurality of servers 10 are connected to one storage device 4, the expression “switches the storage device 4” may be interpreted as “the server 10 being a switching target also shares the storage device 4”

The read processing unit 115 performs reading on the storage device 4 connected to the server 10 itself. Also, the read processing unit 115 places data to be offloaded in the log region of the storage device 4.

FIG. 9 is a diagram illustrating an example of write offloading processing in a storage system as an example of an embodiment.

The storage system 1 illustrated in FIG. 9 includes three servers #0 to #2 and nine storage devices #0 to #8. Note that illustration of the managing server 2 is omitted for simplification.

The servers 10 and the storage devices 4 are communicably connected through the DAN 6, as indicated by a dashed dot frame in the drawing. That is, the server #0 is communicably connected to the storage devices #0 to #2, the server #1 is communicably connected to the storage devices #3 to #5, and the server #2 is communicably connected to the storage devices #6 to #8.

In a case where a data write command is issued to the storage device 4 which is connected to the server 10 itself and is in a power-off state which is connected to the server 10 itself, the read processing unit 115 of the server 10 offloads data to the storage device 4 which is connected to the server 10 itself and another sever 10 and is in a power-on state.

In the example illustrated in FIG. 9, in a case where a data write command is issued to the storage device #0 which is in a power-off state, the server #0 offloads data to the storage devices #1 and #2, the server #1 off loads data to the storage devices #4 and #5, and the server #2 offloads data to the storage devices #7 and #8. Also, in a case where a data write command is issued to the storage device #3 which is in a power-off state, the server #0 offloads data to the storage devices #1 and #2, the server #1 offloads data to the storage devices #4 and #5, and the server #2 offloads data to the storage devices #7 and #8 (not illustrated). Also, in a case where a data write command is issued to the storage device #6 which is in a power-off state, the server #0 offloads data to the storage devices #1 and #2, the server #1 offloads data to the storage devices #4 and #5, and the server #2 off loads data to the storage devices #7 and #8 (not illustrated).

[A-2] Operations

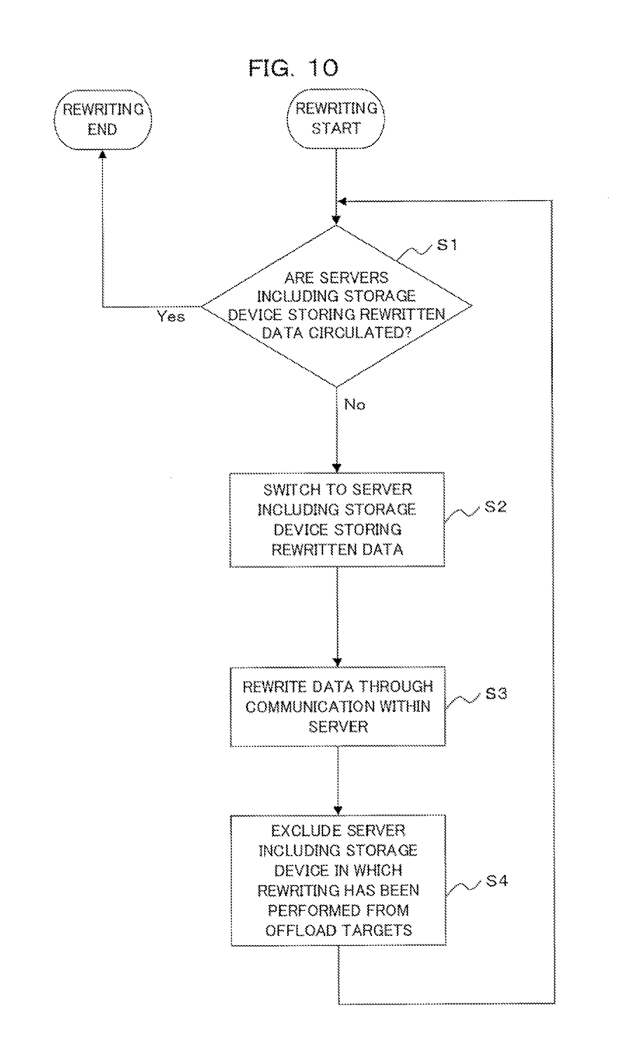

Rewriting processing of offload data in the storage system as an example of an embodiment as configured above will be described according to a flowchart illustrated in FIG. 10 (steps S1 to S4).

When rewriting processing is started, the server 10 having the storage device 4 being a rewriting target determines whether the storage device 4 being a rewriting target circulates all servers 10 each having the storage device 4 in which data to be rewritten (offload data) is stored, by referring to the circulation server list 302 (step S1).

When the storage device 4 being a rewriting target circulates all servers 10 each having the storage device 4 in which data to be rewritten (offload data) is stored (see YES loop of step S1), rewriting processing ends.

On the other hand, when the storage device 4 being a rewriting target does not circulate all servers 10 each having the storage device 4 in which data to be rewritten (offload data) is stored (see No loop of step S1), the switch processing unit 114 switches the storage device being a rewriting target to the server 10 having the storage device 4 that stores the data to be rewritten (step S2).

The rewriting processing unit 113 of the server 10 being a switching target performs rewriting of data through intra-server communication (step S3).

The rewriting management unit 112 excludes the server 10 having the storage device 4 in which rewriting has been performed from offload targets by updating the circulation server list 302 (step S4) and returns to step S1.

Next, a specific example of rewriting processing of offload data according to an example of the present embodiment will described with reference to FIGS. 11 to 15.

The storage system 1 illustrated in FIGS. 11 to 15 includes two servers #0 and #1 and six storage devices #0 to #5. Note that illustration of the managing server 2 is omitted for simplification.

The servers 10 and the storage devices 4 are communicably connected through the DAN 6, as indicated by a dashed dot frame in the drawing. That is, the server #0 is communicably connected to the storage devices #0 to #2 and the server #2 is communicably connected to the storage devices #6 to #8.

FIG. 11 is a diagram illustrating an example of processing of acquiring a circulation server list in a storage system as an example of an embodiment.

The load balancer 3 combines consistent hash and a hash table 301 and performs allocation of requests for the respective storage devices 4. In the hash table 301, data names of offloaded data, identifiers of storage devices which are to store offload data originally, and identifiers of the servers 10 being offload targets are mapped to each other.

In the example illustrated in FIG. 11, the hash table 301 represents that data A to be originally stored in the storage device #0 is offloaded to the server #0. The data A illustrated in the hash table 301 is offloaded to the log regions of the storage devices #1 and #2 connected to the server #0 (see hatched regions of the storage devices #1 and #2). Also, the hash table 301 represents that data B to be originally stored in the storage device #3 is offloaded to the server #0 and data C to be originally stored in the storage device #0 is offloaded to the server #1. The data C illustrated in the hash table 301 is offloaded to the log regions of the storage devices #4 and #5 connected to the server #1 (see cross-hatched regions of the storage devices #4 and #5). The data B illustrated in the hash table 301 is offloaded to at least one of the storage devices #1 and #2 connected to the server #0 but the illustration thereof is omitted for simplification.

For example, when the storage device #0 is supplied with power, the rewriting management unit 112 of the server #0 requests the load balancer 3 to transmit the circulation server list 302 through the network transmitting/receiving unit 111 in order to start rewriting processing for the storage device #0.

The load balancer 3 generates the circulation server list 302 based on the hash table 301 and transmits the circulation server list 302 to the server #0. Specifically, the load balancer 3 generates the circulation server list 302 for each storage device 4 which is to originally store offload data which is registered in the hash table 301. In the example illustrated in FIG. 11, the offload data to be originally stored in the storage device #0 is offloaded to the server #0 as the data A and is off loaded to the server #1 as the data C. The load balancer 3 generates the circulation server list 302 in which whether rewriting of the offload data to be originally stored in the storage device #0 to the servers #0 and #1 is completed can be registered and transmits the circulation server list 302 to the server #0.

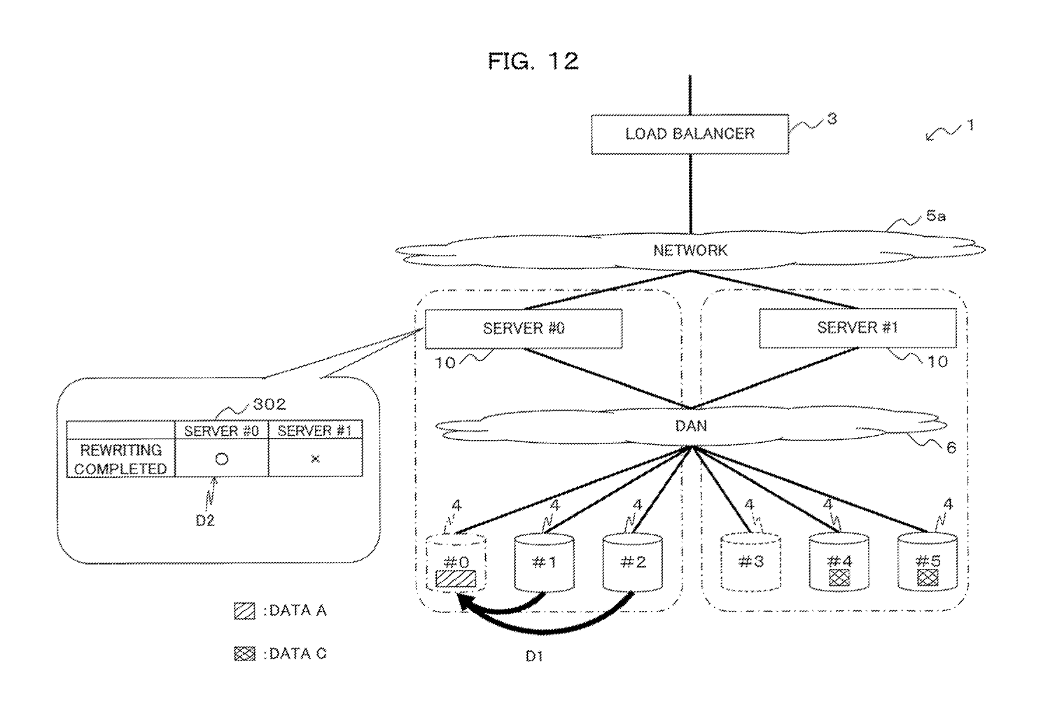

The rewriting management unit 112 of the server #0 acquires the circulation server list 302 transmitted by the load balancer 3 through the network transmitting/receiving unit 111. In the example illustrated in FIG. 11, as indicated by reference sign “x” in the circulation server list 302, it is indicated that rewriting processing to the storage device #0 is not completed for any of the servers 10. On the other hand, when the rewriting processing to the respective servers 10 is completed, the rewriting management unit 112 writes “o” for the server 10 of the circulation server list 302 in which rewriting is completed as described with reference to FIG. 12 below.

The rewriting management unit 112 of the server #0 can recognize which server 10 the storage device #0 needs to circulate (be connected to) for rewriting processing by acquiring in the circulation server list 302. That is, the rewriting management unit 112 can recognize whether data to be rewritten to the storage device #0 is loaded to the storage device 4 connected to the servers #0 and #1.

FIG. 12 is a view illustrating an example of intra-server rewriting processing in a storage system as an example of an embodiment.

The rewriting processing unit 113 detects the storage device 4 being an offload target by reading the log regions of the respective storage devices 4 connected to the server 10 itself and rewrites offload data to the storage device 4 being a rewriting target from the log region of the storage device 4 being an offload target. In the example illustrated in FIG. 12, the rewriting processing unit 113 of the server #0 rewrites offload data (data A in the hash table 301 illustrated in FIG. 11) to the storage device #0 from the storage devices #1 and #2 (see reference sign D1). Since rewriting processing to the storage device #0 from the storage devices #1 and #2 is processing performed within the server #0, inter-node communication does not occur.

When the intra-server rewriting processing is completed by the rewriting processing unit 113, the rewriting management unit 112 updates the circulation server list 302. In the example illustrated in FIG. 12, the rewriting management unit 112 of the server #0 records “o” indicating that rewriting processing in the server #0 is completed in the circulation server list 302 (see reference sign D2). That is, the rewriting management unit 112 excludes the storage devices #1 and #2 being offload targets from offload targets by updating the circulation server list 302.

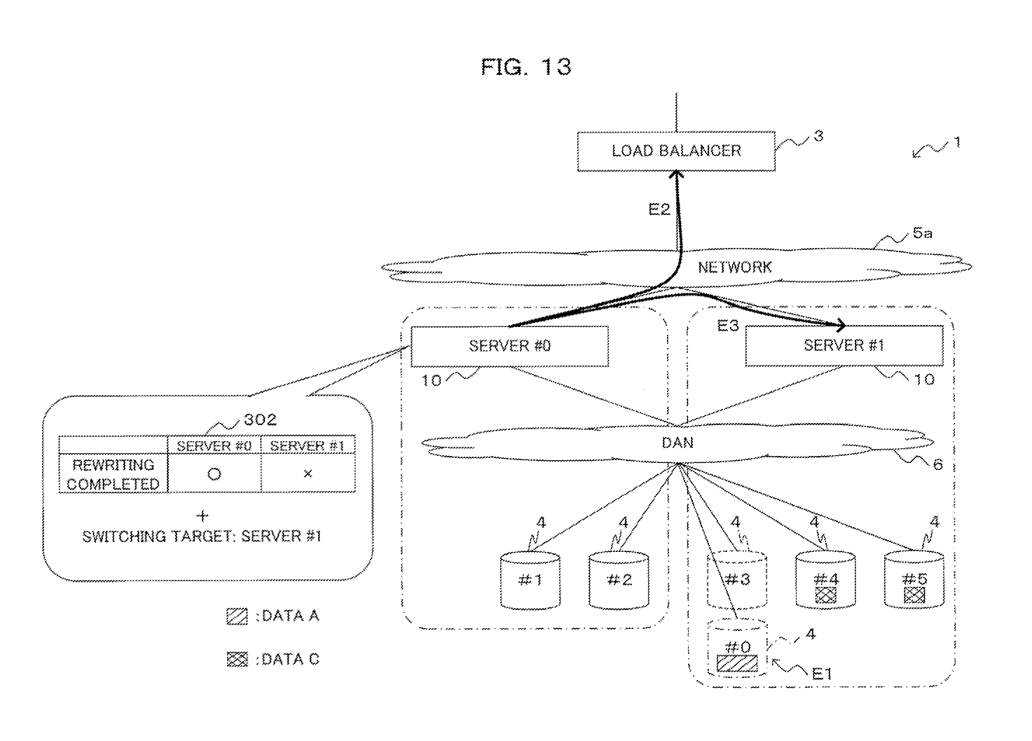

FIG. 13 is a view illustrating an example of processing of switching storage devices in a storage system as an example of an embodiment.

The switch processing unit 114 switches the storage device 4 that is a rewriting target to any server 10 in which rewriting processing is not performed based on the circulation server list 302. In the example illustrated in FIG. 13, the switch processing unit 114 of the server #0 switches the storage device #0 to the server #1 in which non-completion of rewriting processing is registered in the circulation server list 302 (see reference sign E1).

The network transmitting/receiving unit 111 transmits information related to the server 10 being a switching target and the circulation server list 302 that is updated by the rewriting management unit 112 to the load balancer 3 and the server 10 being a switching target. In the example illustrated in FIG. 13, the network transmitting/receiving unit 111 of the server #0 transmits information indicating that the server 10 being a switching target is the server #1 and the updated circulation server list 302 to the load balancer 3 and the server #1 (see reference signs E2 and E3).

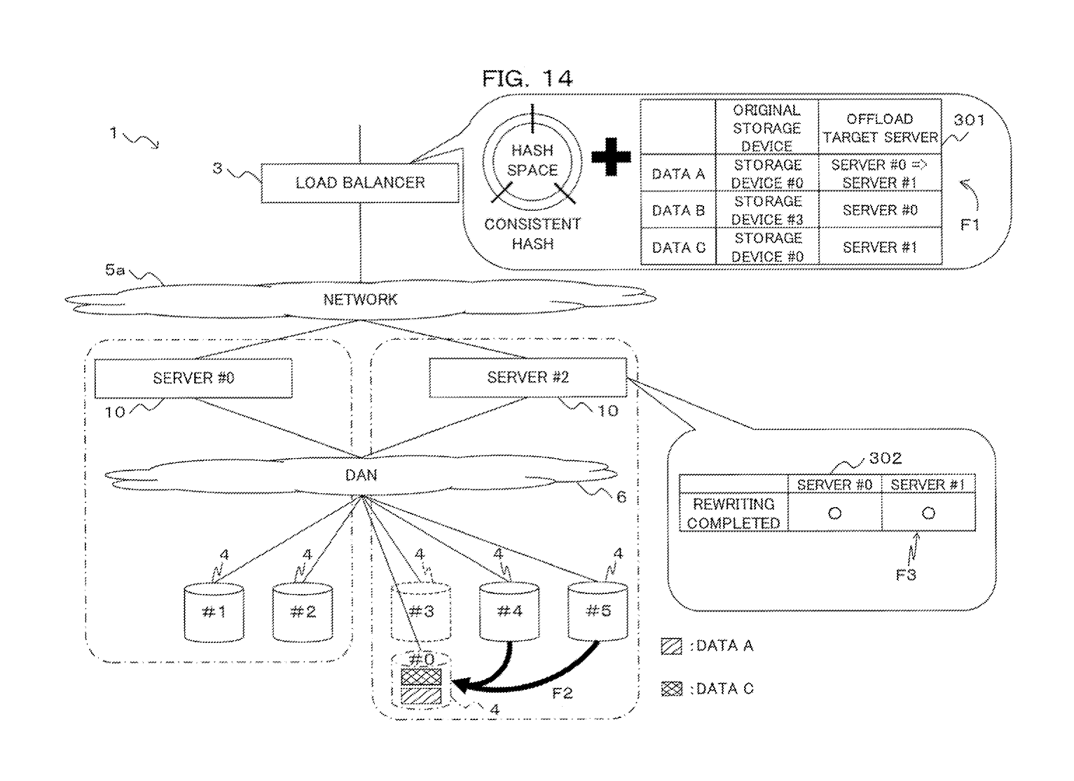

FIG. 14 is a diagram illustrating an example of processing of changing an offload target server in a storage system as an example of an embodiment.

The load balancer 3 updates an offload target server upon write offloading of a rewriting target in the hash table 301, based on received information related to the server 10 being a switching target. In the example illustrated in FIG. 14, the load balancer 3 updates the offload target server for the data A of the hash table 301 from the server #0 to the server #1, based on the received information indicating that the server 10 being a switching target is the server #1 (see reference sign F1). Therefore, when an access request for the data A occurs, the load balancer 3 can transmit the occurring access request to the server #1 instead of the server #0, and accesses the data A even during rewriting processing. In FIG. 14, since rewriting processing for the data C of the hash table 301 has not been performed, the load balancer 3 does not perform updating.

The load balancer 3 may omit a process of updating a hash table 301 indicated by reference sign F1. In this case, when an access request for data A is generated, the load balancer 3 transmits the generated access request to the server #0. Since the rewriting management unit 112 of the server #0 recognizes that the server 10 being a rewrite destination is the server #1, the rewriting management unit 112 transmits (transfers) the received access request to the server #0 through the network transmitting/receiving unit 111. The rewriting management unit 112 can transfer the access request through the network transmitting/receiving unit 111, when it is scheduled to switch to another server 10 as well as after switching the storage device 4 that is a rewriting target to another server 10.

In the following description, processes of rewriting, switching of the storage devices 4, and updating of an offload target are repeatedly performed until rewriting is completed for all servers of a circulation server list 302. In a case where rewriting processing in all servers 10 is completed, the storage device 4 being a rewriting target is switched to an original server 10.

That is, in the example illustrated in FIG. 14, the rewriting processing unit 113 of the server #1 rewrites offload data (data C in the hash table 301) to the storage device #0 from the storage devices #4 and #5 (see reference sign F2). Since rewriting processing to the storage device #0 from the storage devices #4 and #5 is processing performed within the server #1, inter-node communication does not occur.

The rewriting management unit 112 of the server #1 records information indicating that rewriting processing in the server #1 is completed in the circulation server list 302 (see reference sign F3).

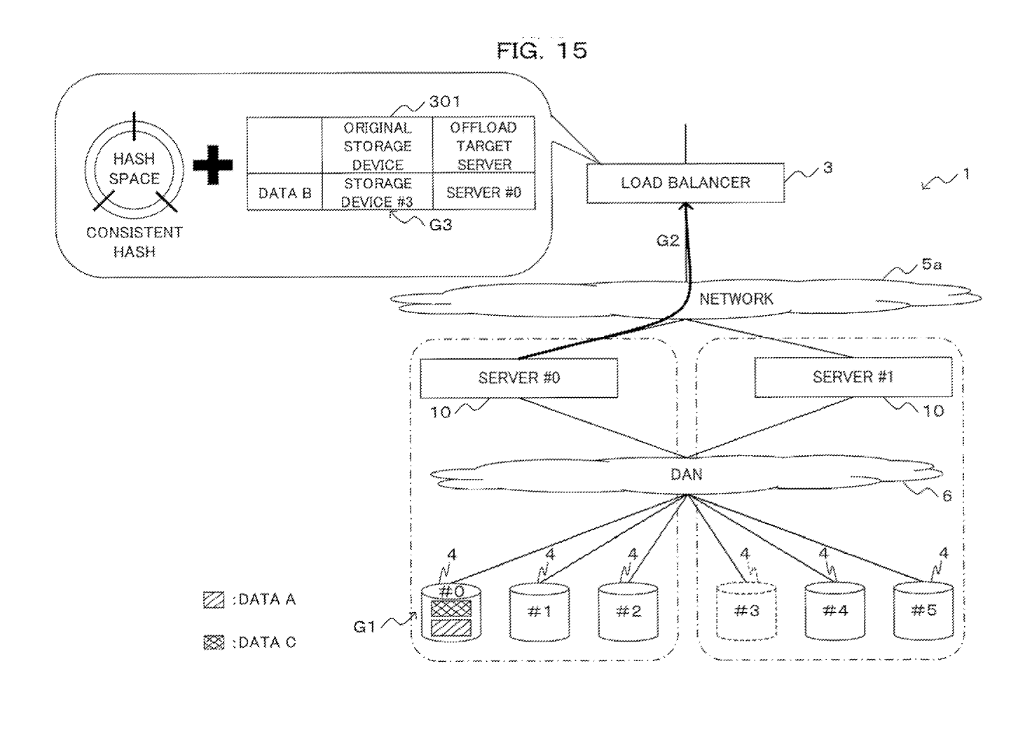

FIG. 15 is a diagram illustrating an exemplary state after rewriting processing of offload data is completed in a storage system as an example of an embodiment.

The switch processing unit 114 switches the storage device 4 that is a rewriting target to any server 10 in which rewriting processing is not performed based on the circulation server list 302. In the example illustrated in FIG. 15, since there is no server 10 in which rewriting processing is not performed, the switch processing unit 114 of the server #1 switches the storage device #0 to the server #0 to which the storage device #0 have been initially connected (see reference sign G1).

The network transmitting/receiving unit 111 transmits information related to the server 10 being a switching target and the circulation server list 302 that is updated by the rewriting management unit 112 to the load balancer 3 and the server 10 being a switching target. That is, the network transmitting/receiving unit 111 of the server #1 transmits information indicating that the server 10 being a switching target is the server #0 and the updated circulation server list 302 to the load balancer 3 and the server #0 (not illustrated).

The rewriting management unit 112 of the server 10 being a switching target notifies the load balancer 3 of the fact that rewriting processing in all servers 10 is completed and the storage device 4 being a rewriting target is connected to the server 10 itself through the network transmitting/receiving unit 111. In the example illustrated in FIG. 15, the rewriting management unit 112 of the server #0 notifies the load balancer 3 of the fact that rewriting processing is completed for the servers #0 and #1 and the storage device #0 is connected to the server #0 itself through the network transmitting/receiving unit 111 (see reference sign G2).

When notification from the server #0 is received, the load balancer 3 removes information about data A and data C of which the rewriting is completed (information related to the storage device #0) from the hash table 301 (see reference sign G3).

[A-3] Effects

As described above, according to the storage system 1 (information processing device 10) according to an example of the present embodiment, it is possible to reduce network load caused by rewriting of data.

Specifically, when the storage device 4 being a rewriting target is connected to the information processing device 10, the rewriting processing unit 113 rewrites data which is temporarily stored in the storage device 4 in which data to be rewritten to the storage device 4 being a rewriting target to the storage device 4 being a rewriting target. After rewriting of data by the rewriting processing unit 113, the switch processing unit 114 connects the storage device 4 being a rewriting target to another information processing device 10 to which the storage device 4, in which data to be stored in the storage device 4 being a rewriting target, is stored is connected. Therefore, it is possible to perform rewriting processing through intra-node communication (local) and reduce network load caused by rewriting of data.

In a case where the switch processing unit 114 connects the storage device 4 being a rewriting target to another information processing device 10, when an access request for the storage device 4 being a rewriting target occurs, the network transmitting/receiving unit 111 transmits the access request to the another information processing device 10. Therefore, it is possible to access the storage device 4 being a rewriting target even during rewriting processing, and to increase availability of the storage system 1.

The switch processing unit 114 connects the storage device 4 being a rewriting target to the another information processing device 10 based on storage destination information 302 acquired by the rewriting management unit 112. Therefore, it is possible to acquire entire offload data by allowing the storage device being a rewriting target to circulate information processing devices 10 each having the storage device 4 which holds data to be rewritten.

The rewriting management unit 112, upon completing rewriting process of the data by the rewriting processing unit 113, updates the storage destination information 302 and transmits the updated storage destination information 302 to the managing device 3. Therefore, it is possible to exclude the storage device 4 in which rewriting is completed from offload targets and to ensure that the storage device 4 in which rewriting is completed does not hold newly offloaded data.

The switch processing unit 114 connects the storage device 4 being a rewriting target to another information processing device 10 by controlling a relay device between the information processing device 10 and the storage device 4 being a rewriting target. Therefore, it is possible to simplify a network configuration between the information processing device 10 and the storage device 4 and to reduce an installation cost of the storage system 1.

Also, it is possible to maintain the storage device 4 that is not frequently used in a power-off state and to reduce an operation cost of the storage system 1. Further, since the log region of the storage device 4 is used as an offload target, there is no need to include a new storage device 4 for write offloading and the installation cost of the storage system 1 can be reduced.

### [B] Others

Note that, a technique of a disclosure is not limited to the foregoing embodiment and various modifications may be made within the scope without departing from the spirit of the embodiment. The appropriate configurations and processes can be chosen as needed from those in the embodiments, or the configurations or processes may also be combined with each other as needed.

According to the information processing device as disclosed, it is possible to reduce network load caused by rewriting of data.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A storage system comprising:
a first information processing device connected to a first storage device; and
a second information processing device connected to a second storage device,
wherein the first information processing device includes a switch processing unit that connects the first storage device to the second information processing device, and
the second information processing device includes a second rewriting processing unit that rewrites data temporarily stored in the second storage device to the first storage device connected to the second information processing device by the switch processing unit.

2. The storage system according to claim 1, wherein the first information processing device is connected to a third storage device, and includes a first rewriting processing unit that rewrites data temporarily stored in the third storage device to the first storage device before the switch processing unit connects the first storage device to the second information processing device.

3. The storage system according to claim 1, wherein the first information processing device includes a transmitting unit that transmits an access request to the second processing device when an access request to the first storage device is generated in a case where the switch processing unit connects the first storage device to the second information processing device.

4. The storage system according to claim 1, wherein the first information processing device includes a rewriting management unit that acquires storage destination information indicating an information processing device including a storage device in which data to be stored in the first storage device is stored, from a managing device included in the storage system, and
the rewriting processing unit connects the first storage device to the second information processing device based on the storage destination information acquired by the rewriting management unit.

5. The storage system according to claim 4, wherein the rewriting management unit, upon completing rewriting process of the data by the rewriting processing unit, updates the storage destination information and transmits the updated storage destination information to the managing device.

6. An information processing device which rewrites data stored in a second storage device to a first storage device, the information processing device comprising:
a rewriting processing unit that rewrites data temporarily stored in the second storage device to the first storage device when the first storage device is connected to the information processing device; and
a switch processing unit that connects the first storage device to another information processing device connected to a third storage device in which data to be stored in the first storage device is stored after the data is rewritten by the data the rewriting processing unit.

7. The information processing device according to claim 6, further comprising a transmitting unit that transmits an access request to the another processing device when an access request to the first storage device is generated in a case where the switch processing unit connects the first storage device to the another information processing device.

8. The information processing device according to claim 6, further comprising a rewriting processing unit that acquires storage destination information indicating an information processing device including a storage device in which data to be stored in the first storage device is stored from a managing device communicably connected to the information processing device,
wherein the rewriting processing unit connects the first storage device to the another information processing device based on the storage destination information acquired by the rewriting management unit.

9. The information processing device according to claim 8, wherein the rewriting management unit, upon completing rewriting process of the data by the rewriting processing unit, updates the storage destination information and transmits the updated storage destination information to the managing device.

10. The information processing device according to claim 6, wherein the switch processing unit connects the first storage device to another information processing device by controlling a relay device between the information processing device and the first storage device.

11. A control method for controlling an information processing device which rewrites data stored in a second storage device to a first storage device, the control method comprising:
rewriting data temporarily stored in the second storage device to the first storage device when the first storage device is connected to the information processing device; and
connecting the first storage device to another information processing device connected to a third storage device in which data to be stored in the first storage device is stored after the data is rewritten.

12. The control method according to claim 11, further comprising transmitting an access request to the another information processing device when an access request to the first storage device is generated in a case of connecting the first storage device to the another information processing device.

13. The control method according to claim 11, further comprising:
acquiring storage destination information indicating an information processing device including a storage device in which data to be stored in the first storage device is stored from a managing device communicably connected to the information processing device; and
connecting the first storage device to the another information processing device based on the acquired storage destination information.

14. The control method according to claim 13, further comprising, upon completing rewriting process of the data, updating the storage destination information and transmitting the updated storage destination information to the managing device.

15. The control method according to claim 11, further comprising connecting the first storage device to the other information processing device by controlling a relay device between the information processing device and the first storage device.
